(19) United States
(12) Patent Application Publication
(10) Pub. No.: US 2024/0179693 A1
(43) Pub. Date: May 30, 2024

(54) BANDWIDTH PART CONFIGURATION METHOD, BANDWIDTH PART CONFIGURATION APAPRATUS, AND STORAGE MEDIUM

(71) Applicant: Beijing Xiaomi Mobile Software Co., Ltd., Beijing (CN)

(72) Inventors: Qin MU, Beijing (CN); Shengxiang GUO, Beijing (CN)

(73) Assignee: Beijing Xiaomi Mobile Software Co., Ltd., Beijing (CN)

(21) Appl. No.: 18/282,310

(22) PCT Filed: Mar. 17, 2021
(86) PCT No.: PCT/CN2021/081389

§ 371 Date: Sep. 15, 2023

(51) Int. Cl. H04W 72/0453; H04L 5/00

(52) U.S. Cl. CPC H04W 72/0453; H04L 5/0094

(57) ABSTRACT

Bandwidth part (BWP) configuration methods, bandwidth part configuration apparatuses and storage media are provided. The bandwidth part configuration method is performed by a terminal, and the method includes: determining at least one of a first BWP pair or a second BWP pair; where the first BWP pair includes a first uplink BWP and a first downlink BWP, and the second BWP pair includes a second uplink BWP and a second downlink BWP; the first uplink BWP and the first downlink BWP have a same center frequency, and the second uplink BWP and the second downlink BWP have different center frequencies.

### CROSS-REFERENCE TO RELATED APPLICATION

The present application is a U.S. National Stage of International Application No. PCT/CN2021/081389, filed on Mar. 17, 2021, the contents of which are incorporated herein by reference in their entirety for all purposes.

### TECHNICAL FIELD

The present disclosure relates to the field of wireless communication technologies, and in particular to, bandwidth part configuration methods, bandwidth part configuration apparatuses and storage media.

### BACKGROUND

In a new generation of communication technology, a terminal can work based on a bandwidth part (BWP). That is, the terminal does not need to monitor the whole bandwidth, but only needs to send and receive data on part of the system bandwidth. In a time division duplex (TDD) system, uplink and downlink data transmissions can share the same bandwidth part. Therefore, in order to reduce a delay of uplink and downlink switching, it is required that the downlink (DL) BWP and the uplink (UL) BWP have the same center frequency.

For a reduced capability (Redcap) terminal, the capability of the Redcap terminal can monitor a DL initial BWP. However, a traditional UL initial BWP may exceed a bandwidth monitored by the Redcap terminal. Based on this, in the related art, the UL initial BWP may be configured separately for the Redcap terminal based on the DL initial BWP frequency range, however, this will limit system scheduling and configuration, and further cause the traditional UL BWP being divided into multiple fragments, resulting in load imbalance.

### SUMMARY

In order to overcome the problems existing in the related art, the present disclosure provides bandwidth part configuration methods, bandwidth part configuration apparatuses and storage media.

According to a first aspect of an embodiment of the present disclosure, a bandwidth part BWP configuration method is provided, which is performed by a terminal, and the method includes: determining at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

According to a second aspect of an embodiment of the present disclosure, a BWP configuration method is provided, which is performed by a network device, and the method includes: determining at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

According to a third aspect of an embodiment of the present disclosure, a BWP configuration apparatus is provided, including: a processor; a memory for storing executable instructions for the processor; where the processor is configured to: determine at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a communication system architecture diagram of a network device and terminals according to an embodiment of the present disclosure.

FIG. 2 is a schematic diagram of configuring a separate UL initial BWP according to an embodiment of the present disclosure.

FIG. 3 is a flowchart of a bandwidth part configuration method according to an embodiment of the present disclosure.

FIG. 4 is a flowchart of another bandwidth part configuration method according to an embodiment of the present disclosure.

FIG. 5 is a flowchart of another bandwidth part configuration method according to an embodiment of the present disclosure.

FIG. 6 is a flowchart of another bandwidth part configuration method according to an embodiment of the present disclosure.

FIG. 7 is a schematic diagram of a bandwidth part configuration method according to an embodiment of the present disclosure.

FIG. 8 is a block diagram of a bandwidth part configuration apparatus according to an embodiment of the present disclosure.

FIG. 9 is a block diagram of another bandwidth part configuration apparatus according to an embodiment of the present disclosure.

FIG. 10 is a block diagram of an apparatus for bandwidth part configuration according to an embodiment of the present disclosure.

FIG. 11 is a block diagram of another apparatus for bandwidth part configuration according to an embodiment of the present disclosure.

### DETAILED DESCRIPTION

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. Embodiments described in the following exemplary embodiments do not represent all embodiments consistent with the present disclosure. Rather, they are merely examples of apparatuses and methods consistent with some aspects of the present disclosure as detailed in the appended claims.

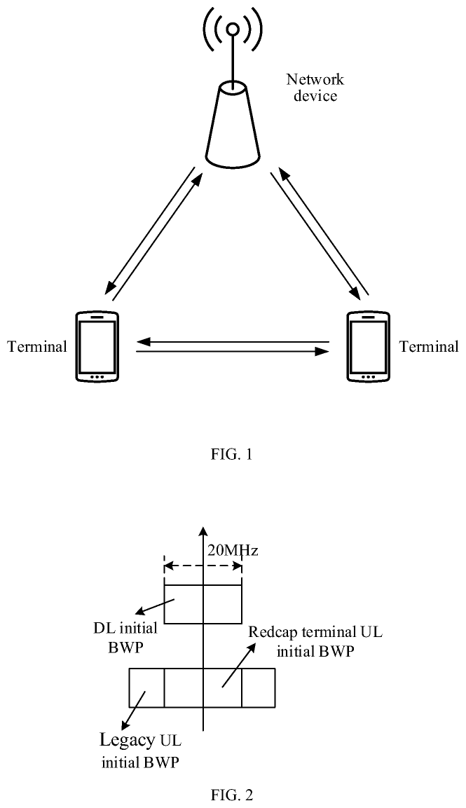

FIG. 1 is a communication system architecture diagram of a network device and terminals according to an embodiment of the present disclosure. The communication methods provided by the present disclosure may be applied in the communication system architecture diagram shown in FIG. 1. As shown in FIG. 1, a network side device may send signaling based on the architecture shown in FIG. 1.

It can be understood that the communication system including a network device and terminals shown in FIG. 1 is only a schematic illustration, and other network devices may further be included in the wireless communication system, such as core network devices, wireless relay devices, wireless backhaul devices, etc., which are not shown in FIG. 1. Embodiments of the present disclosure do not limit the number of network devices and the number of terminals included in the wireless communication system.

It can be further understood that the wireless communication system of the embodiments of the present disclosure is a network providing wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), carrier sense multiple access with collision avoidance, etc. According to factors such as capacity, rate, delay of different networks, networks can be divided into 2-Generation (2G) networks, 3G networks, 4G networks or future evolution networks, such as 5G networks, which can also be called new radio (NR) networks. For ease of description, the present disclosure sometimes refers to a wireless communication network simply as a network.

Furthermore, a network device involved in the present disclosure may also be referred to as a radio access network device. The wireless access network device may be: a base station, an evolved node B, a home base station, an access point (AP) in a wireless fidelity (WIFI) system, a wireless relay node, a wireless backhaul node, a transmission point (TRP), a transmission and reception point (TRP), etc., and it may further be a gNodeB (gNB) in a NR system, or, it may further be a component or a part of devices that constitutes a base station, etc. When it is a vehicle to X (V2X) communication system, the network device can further be a vehicle-mounted device. It should be understood that in the embodiments of the present disclosure, there is no limitation on specific technologies and specific device forms adopted by the network device.

Furthermore, a terminal involved in the present disclosure, which may also be referred to as a terminal device, a user equipment (UE), a mobile station (MS), a mobile terminal (MT), etc., is a device that provides voice and/or data connectivity to a user, e.g., the terminal may be a hand-held device, a vehicle-mounted device, etc., having wireless connectivity. At present, some examples of terminals are: mobile phones, pocket personal computers (PPCs), palmtop computers, personal digital assistant (PDA), notebook computers, tablet computers, wearable devices, or vehicle-mounted devices. In addition, when it is a vehicle to X (V2X) communication system, the terminal device can further be a vehicle-mounted device. It should be understood that the embodiments of the present disclosure do not limit specific technologies and specific device forms adopted by the terminal.

In the new generation of communication technology, a terminal can work based on a bandwidth part (BWP). That is, the terminal does not need to monitor the whole bandwidth, but only needs to send and receive data on part of the system bandwidth. In the time division duplex system, uplink and downlink data transmissions can share the same bandwidth part. Therefore, in order to reduce a delay of uplink and downlink switching, it is required that the DL BWP and the UL BWP have the same center frequency.

The vigorous development of the Internet of Things has brought many conveniences to human life and work. Machine type communication (MTC) and narrow band Internet of things (NB-IOT) technologies are typical representatives of the cellular IoT technology. At present, these technologies have been widely used in many fields such as smart cities (such as meter reading), smart agriculture (such as temperature and humidity information collection) and smart transportation (such as shared-bikes).

In the communication system, for low rate and high delay scenarios (e.g., meter reading, environmental monitoring and other scenes) in the IoT business, the related art proposes two major technologies, MTC and NB-IOT. At present, the NB-IOT technology can support a maximum rate of several hundred Kbps, and MTC can support a maximum rate of several Mbps. However, with the continuous development of IoT business (such as monitoring, smart home, wearable devices, and industrial sensor detection), a speed of tens to 100 Mbps is generally required, and requirements for delay are also increased. Therefore, in the communication system, MTC and NB-IoT may no longer meet the requirements of the current Internet of Things business. At the same time, on the other hand, MTC and NB-IOT technologies are generally deployed in basements, outdoors and other scenes where it is not easy to charge or replace batteries, so a terminal associated with MTC and NB-IOT technologies is limited by hardware, which leads to its coverage capacity is not as good as that of general wireless communication terminals. And due to the impact of the application environment, power saving of its equipment is also a characteristic of MTC and NB IoT technologies. Based on this situation, the requirement of designing another new user equipment in 5G NR to cover this mid-range IoT device has begun to be proposed. In a current 3rd Generation Partnership Project (3GPP) standardization, this new terminal type is called a reduced capability (Redcap) terminal or NR-lite for short. A bandwidth configured for a Redcap terminal is relatively small.

In the Redcap terminal, a capability of the Redcap terminal is that a bandwidth monitoring capability of the Redcap terminal is 20 MHz for radio frequency (RF) 1, and for a downlink channel, an initial BWP is configured for the Redcap terminal separately. It may be implemented in different ways.

In an implementation, an original DL initial BWP is still monitored according to a capability of the Redcap terminal to monitor DL initial BWP. The UL initial BWP can be referred to FIG. 2, which is a schematic diagram of configuring a separate UL initial BWP according to an embodiment of the present disclosure. As shown in FIG. 2, since the UL initial BWP may exceed a capacity of the terminal to monitor the bandwidth, a separate UL initial BWP is correspondingly configured based on a frequency band of the DL initial BWP. In this case, it will bring restrictions on system scheduling and configuration. In an implementation, an independent DL initial BWP and a UL initial BWP are configured for the Redcap terminal, but it will increase additional system message overhead. Moreover, a traditional uplink BWP are fragmented, resulting in unbalanced load.

Based on the problems involved in the above embodiments, the present disclosure provides a BWP configuration method. By configuring different BWP pairs. Where each BWP pair includes a DL initial BWP and a UL initial BWP, moreover, if a downlink BWP and an uplink BWP in one of the BWP pairs may have a same center frequency point, a downlink BWP and an uplink BWP in the other BWP pair may have different center frequency points. Thereby ensuring flexibility in BWP configuration and avoiding splitting the uplink BWP.

The technical solution provided by the embodiments of the present disclosure can include the following beneficial effects: by configuring at least two BWP pairs, and the at least two BWP pairs are asymmetric BWP pairs, a situation of dividing BWP is avoided, and the flexibility of BWP configuration can be ensured.

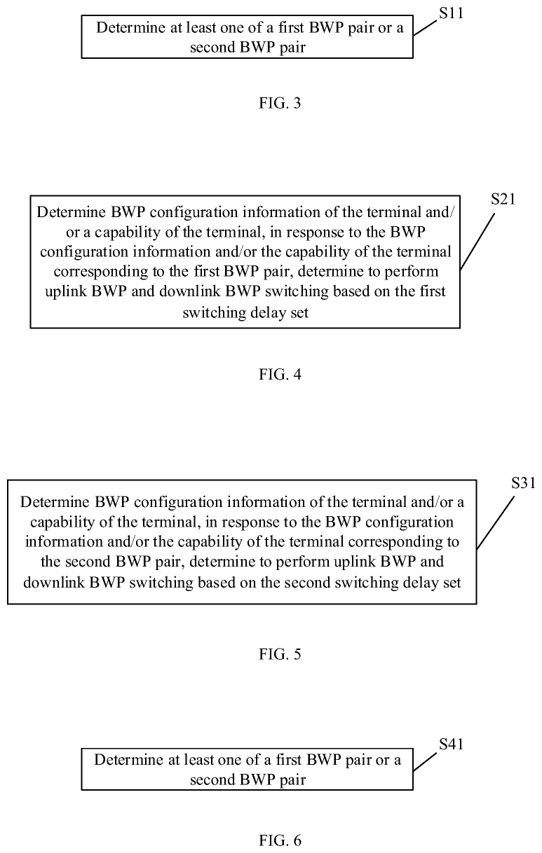

FIG. 3 is a flowchart of a bandwidth part configuration method according to an embodiment of the present disclosure. As shown in FIG. 3, the bandwidth part configuration method is used in a terminal and includes the following step S11.

At step S11, at least one of a first BWP pair or a second BWP pair is determined.

In an embodiment of the present disclosure, the first BWP pair includes a first uplink BWP and a first downlink BWP, and the second BWP pair includes a second uplink BWP and a second downlink BWP. The first uplink BWP and the first downlink BWP have a same center frequency, and the second uplink BWP and the second downlink BWP have different center frequencies. The terminal may determine at least one of the first BWP pair or the second BWP pair according to configurations of network side devices.

According to the bandwidth part configuration method provided by the embodiments of the present disclosure, at least two BWP pairs are configured, and the center frequency points of the two BWPs in at least one BWP pair are different. Thus, the BWP can be avoided from being divided, and flexibility of BWP configuration can be ensured.

In the embodiment of the present disclosure, the first downlink BWP and the second downlink BWP are the same. In other words, the first uplink BWP and the second uplink BWP can correspond to a same BWP, and two BWP pairs can be determined. That is, the first BWP pair and the second BWP pair.

In some embodiments of the present disclosure, the first BWP pair is associated with a first switching delay set, and the second BWP pair is associated with a second switching delay set.

In some embodiments of the present disclosure, the first switching delay set and the second switching delay set both include delay values for a terminal to switch between the uplink BWP and the downlink BWP.

In some examples, if a BWP pair configured by a network for the terminal is the first BWP pair, the terminal performs uplink and downlink switching based on the first switching delay set. If a BWP pair configured by the network for the terminal is the second BWP pair, the terminal performs uplink and downlink switching based on the second switching delay set.

In some embodiments of the present disclosure, the first switching delay set includes a first number of delay values, and the second switching delay set includes a second number of delay values. At least one delay value in the second number of delay values is different from any delay value in the first number of delay values.

In the embodiment of the present disclosure, a maximum delay value of the second switching delay set is greater than a maximum delay value of the first switching delay set. In other words, there is at least one delay value in the second switching delay set that is greater than any of the delay values in the first number of delay values.

In the embodiment of the present disclosure, the second switching delay set at least includes a first subset and a second subset. The first subset corresponds to a first capability of the terminal; and the second subset corresponds to a second capability of the terminal.

In some examples, the first switching delay set related to the embodiments of the present disclosure can be seen in the following Table 1. The second switching delay set related to the embodiments of the present disclosure can be seen in Table 2.

TABLE 1

| Switching delay | | |
|---|---|---|
| (Transition time) | FR1 | FR2 |
| N_{Tx-Rx} | 25600 Ts | 13792 Ts |
| N_{Tx-Rx} | 25600 Ts | 13792 Ts |

It can be understood that each element in Table 1 exists independently, and these elements are listed in the same table by way of example, but it does not mean that all elements in the table must exist at the same time as shown in the table. Each element value is independent of any other element value in Table 1. Therefore, it can be understood by those skilled in the art that each element value in Table 1 is an independent embodiment.

TABLE 2

| Switching delay | FR1 | | FR2 | |
|---|---|---|---|---|
| (Transition time) | Type 1 | Type 2 | Type 1 | Type 2 |
| N_{Tx-Rx} | 25600 Ts | 25600 | 13792 Ts | 13792 |
| | | Ts + δ | | Ts + δ |
| N_{Tx-Rx} | 25600 Ts | 25600 | 13792 Ts | 13792 |
| | | Ts + δ | | Ts + δ |

It can be understood that each element in Table 2 exists independently, and these elements are listed in the same table by way of example, but it does not mean that all elements in the table must exist at the same time as shown in the table. Each element value is independent of any other element value in Table 2. Therefore, it can be understood by those skilled in the art that each element value in Table 2 is an independent embodiment.

FIG. 4 is a flowchart of a bandwidth part configuration method according to an embodiment of the present disclosure. As shown in FIG. 4, the bandwidth part configuration method is used in a terminal and includes the following step S21.

At step S21, BWP configuration information of the terminal and/or a capability of the terminal are determined, in response to the BWP configuration information and/or the capability of the terminal corresponding to the first BWP pair, it is determined to perform uplink BWP and downlink BWP switching based on the first switching delay set.

In the embodiment of the present disclosure, the terminal determines the BWP configuration information configured by the network, and determines that the BWP configuration information configured by the network relates to the first BWP pair and/or the second BWP pair.

In some embodiments of the present disclosure, in response to the BWP configuration information configured by the network for the terminal related to the first BWP pair, the capability of the terminal itself is further determined. According to the capability of the terminal, a delay value for uplink and downlink switching is determined in the first switching delay set associated with the first BWP pair.

In some embodiments of the present disclosure, in response to the BWP configuration information configured by the network for the terminal related to the first BWP pair and the second BWP pair, the capability of the terminal itself is further determined. The first BWP pair is determined to be used in response to the capability of the terminal corresponding to the first BWP pair. The first switching delay set associated with the first BWP pair is determined, and in the first switching delay set, the delay value for uplink and downlink switching is determined according to the capability of the terminal.

FIG. 5 is a flowchart of a bandwidth part configuration method according to an embodiment of the present disclosure. As shown in FIG. 5, the bandwidth part configuration method is used in a terminal and includes the following step S31.

At step S31, BWP configuration information of the terminal and/or a capability of the terminal are determined, in response to the BWP configuration information and/or the capability of the terminal corresponding to the second BWP pair, it is determined to perform uplink BWP and downlink BWP switching based on the second switching delay set.

In the embodiment of the present disclosure, the terminal determines the BWP configuration information configured by the network, and determines that the BWP configuration information configured by the network includes the first BWP pair and/or the second BWP pair.

In some embodiments of the present disclosure, in response to the BWP configuration information configured by the network for the terminal corresponding to the second BWP pair, the capability of the terminal itself is further determined. According to the capability of the terminal, a subset corresponding to the capability of the terminal is determined in the second switching delay set associated with the second BWP pair, and the delay value for uplink and downlink switching is determined in the subset.

In some embodiments of the present disclosure, in response to the BWP configuration information configured by the network for the terminal being the first BWP pair and the second BWP pair, the capability of the terminal itself is further determined. In response to the capability of the terminal corresponding to the second BWP pair, the second switching delay set associated with the second BWP pair is determined. In the second switching delay set, the subset corresponding to the capability of the terminal is determined, and the delay value for uplink and downlink switching is determined in the subset.

In the embodiments of the present disclosure, each of the above embodiments can be implemented in a TDD system. Of course, this is only an example, and it is not a specific limitation of the present disclosure.

Based on the same/similar concept, the embodiments of the present disclosure further provide a bandwidth part configuration apparatus.

FIG. 6 is a flowchart of a bandwidth part configuration method according to an embodiment of the present disclosure. As shown in FIG. 6, the bandwidth part configuration method is used in a network side device and includes the following step S41.

At step S41, at least one of a first BWP pair or a second BWP pair is determined.

In an embodiment of the present disclosure, the network side device determines a first BWP pair and a second BWP pair. The first BWP pair includes a first uplink BWP and a first downlink BWP, and the second BWP pair includes a second uplink BWP and a second downlink BWP. The first uplink BWP and the first downlink BWP have a same center frequency, and the second uplink BWP and the second downlink BWP have different center frequencies. The network side device can determine at least one BWP pair for the terminal among the first BWP pair and the second BWP pair.

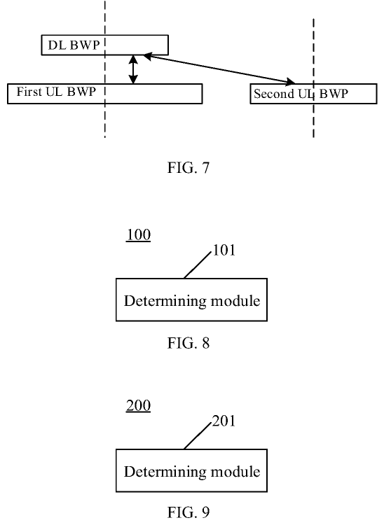

In the embodiment of the present disclosure, the first downlink BWP and the second downlink BWP are the same. FIG. 7 is a schematic diagram of a bandwidth part configuration method according to an embodiment of the present disclosure. As shown in FIG. 7, the first uplink BWP and the second uplink BWP can correspond to a same BWP, and two BWP pairs can be determined, that is, the first BWP pair and the second BWP pair. The network side device can further configure two or more uplink BWPs for a same downlink BWP to obtain two or more BWP pairs, which is not illustrated here.

In some embodiments of the present disclosure, the first BWP pair is associated with a first switching delay set, and the second BWP pair is associated with a second switching delay set.

In some embodiments of the present disclosure, the first switching delay set and the second switching delay set both include delay values for a terminal to switch between the uplink BWP and the downlink BWP.

In some examples, if a BWP pair configured by a network for the terminal is the first BWP pair, then the terminal performs uplink and downlink switching based on the first switching delay set. If a BWP pair configured by the network for the terminal is the second BWP pair, the terminal performs uplink and downlink switching based on the second switching delay set.

In some embodiments of the present disclosure, the first switching delay set includes a first number of delay values, and the second switching delay set includes a second number of delay values. At least one delay value in the second number of delay values is different from any delay value in the first number of delay values.

In some embodiments of the present disclosure, a maximum delay value of the second switching delay set is greater than a maximum delay value of the first switching delay set. In other words, there is at least one delay value in the second switching delay set that is greater than any of the delay values in the first number of delay values.

In some embodiments of the present disclosure, the second switching delay set at least includes a first subset and a second subset. The first subset corresponds to a first capability of the terminal. The second subset corresponds to a second capability of the terminal.

In some examples, the first switching delay set related to the embodiments of the present disclosure can be seen in Table 1 of the above embodiments. The first switching delay set related to the embodiments of the present disclosure can be seen in Table 2 of the above embodiments.

In the embodiment of the present disclosure, the terminal determines the BWP configuration information configured by the network, and determines that the BWP configuration information configured by the network relates to the first BWP pair and/or the second BWP pair.

In some embodiments of the present disclosure, in response to the BWP configuration information configured by the network for the terminal related to the first BWP pair, a capability of the terminal itself is further determined. According to the capability of the terminal, a delay value for uplink and downlink switching is determined in the first switching delay set associated with the first BWP pair.

In some embodiments of the present disclosure, in response to the BWP configuration information configured by the network for the terminal being the first BWP pair and the second BWP pair, the capability of the terminal itself is further determined. The first BWP pair is determined to be used in response to the capability of the terminal corresponding to the first BWP pair. The first switching delay set associated with the first BWP pair is determined, and in the first switching delay set, the delay value for uplink and downlink switching is determined according to the capability of the terminal.

In the embodiment of the present disclosure, the terminal determines the BWP configuration information configured by the network, and determines that the BWP configuration information configured by the network includes the first BWP pair and/or the second BWP pair.

In some embodiments of the present disclosure, in response to the BWP configuration information configured by the network for the terminal corresponding to the second BWP pair, the capability of the terminal itself is further determined. According to the capability of the terminal, a subset corresponding to the capability of the terminal is determined in the second switching delay set associated with the second BWP pair, and the delay value for uplink and downlink switching is determined in the subsets.

In some embodiments of the present disclosure, in response to the BWP configuration information configured by the network for the terminal related to the first BWP pair and the second BWP pair, the capability of the terminal itself is further determined. In response to the capability of the terminal corresponding to the second BWP pair, the second switching delay set associated with the second BWP pair is determined. In the second switching delay set, a subset corresponding to the capability of the terminal is determined, and the delay value for uplink and downlink switching is determined in the subset.

In the embodiments of the present disclosure, each of the above embodiments can be implemented in a TDD system. Of course, this is only an example, and it is not a specific limitation of the present disclosure.

Based on the same/similar concept, embodiments of the present disclosure further provide a bandwidth part configuration apparatus.

It can be understood that, in order to realize the above functions, the bandwidth configuration apparatus provided by the embodiments of the present disclosure includes corresponding hardware structures and/or software modules for performing various functions. Combining the units and algorithm steps of various examples in embodiments of the present disclosure, the embodiments of the present disclosure can be realized in the form of hardware or a combination of hardware and computer software. Whether a function is executed by hardware or computer software drives hardware depends on the specific application and design constraints of the technical solution. Those skilled in the art can use different methods to realize the described functions for each specific application, but such implementation should not be considered beyond the scope of the technical solution of the embodiments of the present disclosure.

FIG. 8 is a block diagram of a bandwidth part configuration apparatus 100 according to an embodiment of the present disclosure. Referring to FIG. 8, the BWP configuration apparatus 100, which is performed by a terminal, includes a determining module 101.

The determining module 101 is configured to determine at least one of a first BWP pair or a second BWP pair. Where the first BWP pair includes a first uplink BWP or a first downlink BWP, and the second BWP pair includes a second uplink BWP and a second downlink BWP. The first uplink BWP and the first downlink BWP have a same center frequency, and the second uplink BWP and the second downlink BWP have different center frequencies.

In the embodiment of the present disclosure, the first downlink BWP is same as the second downlink BWP.

In the embodiment of the present disclosure, the first BWP pair is associated with a first switching delay set, and the second BWP pair is associated with a second switching delay set. The first switching delay set and the second switching delay set both include delay values for a terminal to switch between the uplink BWP and the downlink BWP.

In the embodiment of the present disclosure, the first switching delay set includes a first number of delay values, and the second switching delay set includes a second number of delay values. At least one delay value in the second number of delay values is different from any delay value in the first number of delay values.

In some embodiments of the present disclosure, a maximum delay value of the second switching delay set is greater than a maximum delay value of the first switching delay set.

In the embodiment of the present disclosure, the second switching delay set at least includes a first subset and a second subset. The first subset corresponds to a first capability of the terminal. The second subset corresponds to a second capability of the terminal.

In the embodiment of the present disclosure, the determining module 101 is configured to: determine BWP configuration information of the terminal and/or a capability of the terminal, in response to the BWP configuration information and/or the capability of the terminal corresponding to the first BWP pair, and perform uplink BWP and downlink BWP switching based on the first switching delay set.

In the embodiment of the present disclosure, the determining module 101 is further configured to determine BWP configuration information of the terminal and/or the capability of the terminal, in response to the BWP configuration information and/or the capability of the terminal corresponding to the second BWP pair, and perform uplink BWP and downlink BWP switching based on the second switching delay set.

FIG. 9 is a block diagram of a bandwidth part configuration apparatus 200 according to an embodiment of the present disclosure. Referring to FIG. 9, the BWP configuration apparatus 200, which is performed by a network device, includes a determining module 201.

The determining module 201 is configured to determine at least one of a first BWP pair or a second BWP pair. Where the first BWP pair includes a first uplink BWP or a first downlink BWP, and the second BWP pair includes a second uplink BWP and a second downlink BWP. The first uplink BWP and the first downlink BWP have a same center frequency, and the second uplink BWP and the second downlink BWP have different center frequencies.

In the embodiment of the present disclosure, the first downlink BWP is same as the second downlink BWP.

In the embodiment of the present disclosure, the first BWP pair is associated with a first switching delay set, and the second BWP pair is associated with a second switching delay set. The first switching delay set and the second switching delay set include delay values for a terminal to switch the uplink BWP and the downlink BWP.

In the embodiment of the present disclosure, the first switching delay set includes a first number of delay values. The second switching delay set includes a second number of delay values, at least one delay value in the second number of delay values is different from any delay value in the first number of delay values.

In the embodiment of the present disclosure, a maximum delay value of the second switching delay set is greater than a maximum delay value of the first switching delay set.

In the embodiment of the present disclosure, the second switching delay set at least includes a first subset and a second subset. The first subset corresponds to a first capability of the terminal. The second subset corresponds to a second capability of the terminal.

Regarding to the apparatus in the above embodiment, a specific way in which each module performs operations has been described in detail in the embodiments relating to the method, and are not re-described in detail here.

The determining modules 101 and 201 may be any type of known processor, including but not limited to any combination of a central processing unit (CPU), control unit (CU), graphics processing unit (GPU), micro-processors, etc.

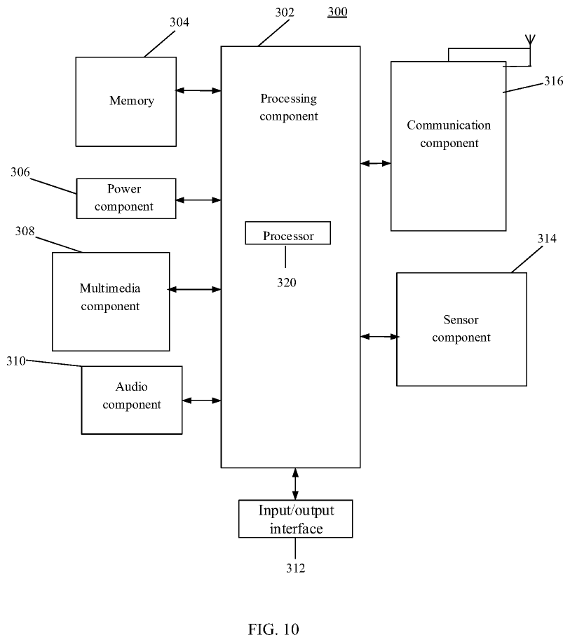

FIG. 10 is a block diagram of an apparatus 300 for bandwidth part configuration according to an embodiment of the present disclosure. For example, the apparatus 300 may be a mobile phone, a computer, a digital broadcasting terminal, a messaging device, a game console, a tablet device, a medical device, a fitness device, a personal digital assistant, etc.

Referring to FIG. 10, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the apparatus 300, such as operations associated with display, telephone call, data communication, camera operation and recording operation. The processing component 302 may include one or more processors 320 to execute instructions to complete all or part of steps of the above-mentioned method. In addition, the processing component 302 may include one or more modules to facilitate interactions between the processing component 302 and other components. For example, the processing component 302 may include a multimedia module to facilitate interactions between the multimedia component 308 and the processing component 302.

The memory 304 is configured to store various types of data to support operations in the apparatus 300. Examples of these data include instructions of any application program or method for being operated on the apparatus 300, contact data, phone book data, messages, pictures, videos, etc. The memory 304 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 306 provides power to various components of the apparatus 300. The power component 306 may include a power management system, one or more power supplies, and other components associated with generating, managing and distributing power for the apparatus 300.

The multimedia component 308 includes a screen that provides an output interface between the apparatus 300 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 308 includes a front camera and/or a rear camera. When the apparatus 300 is in an operation mode, such as a shooting mode or a video mode, the front camera and/or the rear camera can receive external multimedia data. Each front camera and rear camera may be a fixed optical lens system or have focal length and optical zoom capability.

The audio component 310 is configured to output and/or input audio signals. For example, the audio component 310 includes a microphone (MIC) configured to receive external audio signals when the apparatus 300 is in the operation mode, such as a calling mode, a recording mode and a voice recognition mode. The received audio signal may be further stored in the memory 304 or transmitted via the communication component 316. In some embodiments, the audio component 310 further includes a speaker for outputting audio signals.

The I/O interface 312 provides an interface between the processing component 302 and peripheral interface modules, where the peripheral interface modules may be keyboards, click-wheels, buttons, etc. These buttons may include, but are not limited to: home button, volume button, start button and lock button.

The sensor component 314 includes one or more sensors for providing various aspects of state evaluation for the apparatus 300. For example, the sensor component 314 can detect an on/off state of the apparatus 300, a relative positioning of components, for example, the components are the display and the keypad of the apparatus 300, and the sensor component 314 can also detect a position change of the apparatus 300 or a component of the apparatus 300, presence or absence of user contact with the apparatus 300, orientation or acceleration/deceleration of the apparatus 300 and a temperature change of the apparatus 300. The sensor component 314 may include a proximity sensor configured to detect presence of a nearby object without any physical contact. The sensor component 314 may also include an optical sensor, such as a CMOS or CCD image sensor, for use in imaging applications. In some embodiments, the sensor component 314 may further include an acceleration sensor, a gyroscope sensor, a magnetic sensor, a pressure sensor or a temperature sensor.

The communication component 316 is configured to facilitate wired or wireless communication between the apparatus 300 and other devices. The apparatus 300 can access a wireless network based on communication standards, such as WiFi, 2G or 3G, or combinations thereof. In an embodiment of the present disclosure, the communication component 316 receives a broadcast signal or broadcast related information from an external broadcast management system via a broadcast channel. In an embodiment of the present disclosure, the communication component 316 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 300 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 304 including instructions, where the instructions can be executed by a processor 320 of the apparatus 300 to complete the above-mentioned delay determination method. For example, the non-transitory computer-readable storage medium may be an ROM, a random access memory (RAM), a CD-ROM, a magnetic tape, a floppy disk, an optical data storage device, etc.

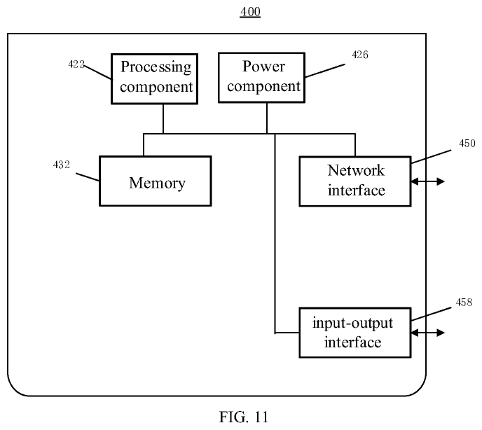

FIG. 11 is a block diagram of an apparatus 400 for bandwidth part configuration according to an embodiment of the present disclosure. For example, the apparatus 400 may be provided as a server. Referring to FIG. 11, the apparatus 400 includes a processing component 422, which further includes one or more processors (not shown), and memory resources represented by a memory 432 for storing instructions that can be executed by the processing component 422, such as application programs. An application program stored in the memory 432 may include one or more modules each corresponding to a set of instructions. In addition, the processing component 422 is configured to execute instructions to perform the method described above.

The apparatus 400 may further include a power component 426 configured to perform power management of the apparatus 400, a wired or wireless network interface 450 configured to connect the apparatus 400 to a network, and an input-output (I/O) interface 458. The apparatus 400 can operate based on an operating system stored in the memory 432, such as Windows Server™, Mac OS X™, Unix™, Linux™, FreeBSD™ or the like.

According to a first aspect of an embodiment of the present disclosure, a bandwidth part BWP configuration method is provided, which is performed by a terminal, and the method includes: determining at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

In an embodiment, the first downlink BWP is same as the second downlink BWP.

In an embodiment, the first BWP pair is associated with a first switching delay set, and the second BWP pair is associated with a second switching delay set, and the first switching delay set and the second switching delay set include delay values for the terminal to switch the uplink BWP and the downlink BWP.

In an embodiment, the first switching delay set includes a first number of delay values, the second switching delay set includes a second number of delay values; and at least one delay value in the second number of delay values is different from any delay value in the first number of delay values.

In an embodiment, a maximum delay value of the second switching delay set is greater than a maximum delay value of the first switching delay set.

In an embodiment, the second switching delay set at least includes a first subset and a second subset, the first subset corresponds to a first capability of the terminal, and the second subset corresponds to a second capability of the terminal.

In an embodiment, the method further includes: determining BWP configuration information of the terminal and/or a capability of the terminal, in response to the BWP configuration information and/or the capability of the terminal corresponding to the first BWP pair, performing uplink BWP and downlink BWP switching based on the first switching delay set; or determining the BWP configuration information of the terminal and/or the capability of the terminal, in response to the BWP configuration information and/or the capability of the terminal corresponding to the second BWP pair, performing uplink BWP and downlink BWP switching based on the second switching delay set.

According to a second aspect of an embodiment of the present disclosure, a BWP configuration method is provided, which is performed by a network device, and the method includes: determining at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

In an embodiment, the first downlink BWP is same as the second downlink BWP.

In an embodiment, the first BWP pair is associated with a first switching delay set, the second BWP pair is associated with a second switching delay set, and the first switching delay set and the second switching delay set include delay values for a terminal to switch the uplink BWP and the downlink BWP.

In an embodiment, the first switching delay set includes a first number of delay values, the second switching delay set includes a second number of delay values, and at least one delay value in the second number of delay values is different from any delay value in the first number of delay values.

In an embodiment, a maximum delay value of the second switching delay set is greater than a maximum delay value of the first switching delay set.

In an embodiment, the second switching delay set at least includes a first subset and a second subset, the first subset corresponds to a first capability of the terminal, and the second subset corresponds to a second capability of the terminal.

According to a third aspect of an embodiment of the present disclosure, a BWP configuration apparatus is provided, which is performed by a terminal, and the apparatus includes: a determining module, configured to determine at least one of a first BWP pair or a second BWP pair; where the first BWP pair includes a first uplink BWP and a first downlink BWP, the second BWP pair includes a second uplink BWP and a second downlink BWP, the first uplink BWP and the first downlink BWP have a same center frequency, and the second uplink BWP and the second downlink BWP have different center frequencies.

In an embodiment, the first downlink BWP is same as the second downlink BWP.

In an embodiment, the first BWP pair is associated with a first switching delay set, the second BWP pair is associated with a second switching delay set, and the first switching delay set and the second switching delay set include delay values for the terminal to switch the uplink BWP and the downlink BWP.

In an embodiment, the first switching delay set includes a first number of delay values, the second switching delay set includes a second number of delay values; and at least one delay value in the second number of delay values is different from any delay value in the first number of delay values.

In an embodiment, a maximum delay value of the second switching delay set is greater than a maximum delay value of the first switching delay set.

In an embodiment, the second switching delay set at least includes a first subset and a second subset, the first subset corresponds to a first capability of the terminal, and the second subset corresponds to a second capability of the terminal.

In an embodiment, the determining module is configured to: determine BWP configuration information of the terminal and/or a capability of the terminal, in response to the BWP configuration information and/or the capability of the terminal corresponding to the first BWP pair, perform uplink BWP and downlink BWP switching based on the first switching delay set; or determine the BWP configuration information of the terminal and/or the capability of the terminal, in response to the BWP configuration information and/or the capability of the terminal corresponding to the second BWP pair, perform uplink BWP and downlink BWP switching based on the second switching delay set.

According to a fourth aspect of an embodiment of the present disclosure, a BWP configuration apparatus is provided, which is performed by a network side device, and the apparatus includes: a determining module, configured to determine at least one of a first BWP pair or a second BWP pair; where the first BWP pair includes a first uplink BWP and a first downlink BWP, the second BWP pair includes a second uplink BWP and a second downlink BWP; the first uplink BWP and the first downlink BWP have a same center frequency, and the second uplink BWP and the second downlink BWP have different center frequencies.

In an embodiment, the first downlink BWP is same as the second downlink BWP.

In an embodiment, the first BWP pair is associated with a first switching delay set, the second BWP pair is associated with a second switching delay set, and the first switching delay set and the second switching delay set include delay values for a terminal to switch the uplink BWP and the downlink BWP.

In an embodiment, the first switching delay set includes a first number of delay values, the second switching delay set includes a second number of delay values, and at least one delay value in the second number of delay values is different from any delay value in the first number of delay values.

In an embodiment, a maximum delay value of the second switching delay set is greater than a maximum delay value of the first switching delay set.

In an embodiment, the second switching delay set at least includes a first subset and a second subset, the first subset corresponds to a first capability of the terminal, and the second subset corresponds to a second capability of the terminal.

According to a fifth aspect of an embodiment of the present disclosure, a BWP configuration apparatus is provided, including: a processor; a memory for storing executable instructions for the processor; where the processor is configured to: perform the BWP configuration method described in the first aspect or any of implementations in the first aspect, or, perform the BWP configuration method described in the second aspect or any of implementations in the second aspect.

According to a sixth aspect of an embodiment of the present disclosure, a non-transitory computer-readable storage medium is provided, which, when instructions in the storage medium are executed by a processor of a mobile terminal, enables the mobile terminal to execute the BWP configuration method described in the first aspect or any of implementations in the first aspect, or enables the mobile terminal to execute the BWP configuration method described in the second aspect or any of implementations in the second aspect.

It can be further understood that “plurality” in the present disclosure means two or more, and that other quantifiers are similar. “And/or”, which describes the relationship of related objects, means that there can be three kinds of relationships, for example, A and/or B, which can mean that A exists alone, A and B exist together, and B exists alone. The character “/” generally indicates that the associated object is an “or” relationship. Singular forms of “a”, “said”, and “the” are also intended to include majority forms, unless the context clearly indicates otherwise.

It can be further understood that the terms “first”, “second”, etc. may be used to describe various information, but this information should not be limited to these terms. These terms are used only to distinguish the same type of information from one another and do not indicate a specific order or degree of importance. In fact, expressions such as “first” and “second” can be used interchangeably. For example, without departing from the scope of the present disclosure, first information can also be called second information, and similarly, the second information can also be called the first information.

It can be further understood that although the operations are described in a specific order in the accompanying drawings in the embodiments of the present disclosure, it should not be understood as requiring that these operations be performed in the specific order or serial order shown, or that all the operations shown should be performed to obtain the desired results. In certain circumstances, multitasking and parallel processing may be beneficial.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A bandwidth part (BWP) configuration method, performed by a terminal, comprising:
determining at least one of a first BWP pair or a second BWP pair;
wherein the first BWP pair comprises a first uplink BWP and a first downlink BWP,
the second BWP pair comprises a second uplink BWP and a second downlink BWP,
the first uplink BWP and the first downlink BWP have a same center frequency, and
the second uplink BWP and the second downlink BWP have different center frequencies.

2. The BWP configuration method according to claim 1, wherein the first downlink BWP is same as the second downlink BWP.

3. The BWP configuration method according to claim 1, wherein
the first BWP pair is associated with a first switching delay set, and the second BWP pair is associated with a second switching delay set; and
the first switching delay set and the second switching delay set comprise delay values for the terminal to switch the uplink BWP and the downlink BWP.

4. The BWP configuration method according to claim 3, wherein
the first switching delay set comprises a first number of delay values, the second switching delay set comprises a second number of delay values; and
at least one delay value in the second number of delay values is different from any delay value in the first number of delay values.

5. The BWP configuration method according to claim 3, wherein a maximum delay value of the second switching delay set is greater than a maximum delay value of the first switching delay set.

6. The BWP configuration method according to claim 3, wherein
the second switching delay set at least comprises a first subset and a second subset,
the first subset corresponds to a first capability of the terminal, and
the second subset corresponds to a second capability of the terminal.

7. The BWP configuration method according to claim 3, further comprising:
determining at least one of BWP configuration information of the terminal or a capability of the terminal, wherein at least one of the BWP configuration information and/or the capability of the terminal corresponding to the first BWP pair; and
performing uplink BWP and downlink BWP switching based on the first switching delay set.

8. A bandwidth part (BWP) configuration method, performed by a network side device, comprising:
determining at least one of a first BWP pair or a second BWP pair;
wherein the first BWP pair comprises a first uplink BWP and a first downlink BWP,
the second BWP pair comprises a second uplink BWP and a second downlink BWP,
the first uplink BWP and the first downlink BWP have a same center frequency, and
the second uplink BWP and the second downlink BWP have different center frequencies.

9. The BWP configuration method according to claim 8, wherein the first downlink BWP is same as the second downlink BWP.

10. The BWP configuration method according to claim 8, wherein
the first BWP pair is associated with a first switching delay set, the second BWP pair is associated with a second switching delay set, and
the first switching delay set and the second switching delay set comprise delay values for a terminal to switch the uplink BWP and the downlink BWP.

11. The BWP configuration method according to claim 10, wherein
the first switching delay set comprises a first number of delay values,
the second switching delay set comprises a second number of delay values, and
at least one delay value in the second number of delay values is different from any delay value in the first number of delay values.

12. The BWP configuration method according to claim 10, wherein a maximum delay value of the second switching delay set is greater than a maximum delay value of the first switching delay set.

13. The BWP configuration method according to claim 10, wherein
the second switching delay set at least comprises a first subset and a second subset,
the first subset corresponds to a first capability of the terminal, and
the second subset corresponds to a second capability of the terminal.

14-15. (canceled)

16. A device, comprising:
a processor; and
a memory, configured to store processor-executable instructions;
wherein the processor is configured to; determine at least one of a first bandwidth part (BWP) pair or a second BWP pair;
wherein the first BWP pair comprises a first uplink BWP and a first downlink BWP,
the second BWP pair comprises a second uplink BWP and a second downlink BWP,
the first uplink BWP and the first downlink BWP have a same center frequency, and
the second uplink BWP and the second downlink BWP have different center frequencies.

17. A non-transitory computer-readable storage medium, which, when instructions in a storage medium are executed by a processor of a mobile terminal, enables the mobile terminal to execute the BWP configuration method according to claim 1.

18. The BWP configuration method according to claim 3, further comprising:
determining at least one of BWP configuration information of the terminal or a capability of the terminal, wherein at least one of the BWP configuration information or the capability of the terminal correspond to the second BWP pair;
performing uplink BWP and downlink BWP switching based on the second switching delay set.

19. The device according to claim 16, wherein the first downlink BWP is same as the second downlink BWP.

20. The device according to claim 16, wherein
the first BWP pair is associated with a first switching delay set, and the second BWP pair is associated with a second switching delay set; and
the first switching delay set and the second switching delay set comprise delay values for the terminal to switch the uplink BWP and the downlink BWP.

21. The device according to claim 20, wherein
the first switching delay set comprises a first number of delay values, the second switching delay set comprises a second number of delay values; and
at least one delay value in the second number of delay values is different from any delay value in the first number of delay values.

22. The device according to claim 20, wherein a maximum delay value of the second switching delay set is greater than a maximum delay value of the first switching delay set.
